(19) United States
(12) Patent Application Publication
(10) Pub. No.: US 2025/0135651 A1
(43) Pub. Date: May 1, 2025

(54) GUIDE ROBOT, CONTROL SERVER, AND GUIDE ROBOT CONTROL METHOD

(71) Applicants: Hyundai Motor Company, Seoul (KR); Kia Corporation, Seoul (KR)

(72) Inventor: Jae Hag Jung, Seoul (KR)

(21) Appl. No.: 18/598,896

(22) Filed: Mar. 7, 2024

(30) Foreign Application Priority Data
Oct. 27, 2023 (KR) 10-2023-0145798

(51) Int. Cl. B25J 9/16; G06V 40/16

(52) U.S. Cl. CPC B25J 9/1697; B25J 9/1664; G06V 40/16

(57) ABSTRACT

A guide robot can include a position recognition device configured to recognize a position, an image recognition device configured to recognize a user from a target image, a behavior controller configured to transmit to a content recommendation device a request for generating a target contents list in which a position of the guide robot and a characteristic of the user are reflected, and outputs the target contents list through an output device of the guide robot, and the content recommendation device is configured to combine the position with map information to generate first feature data, generate second feature data about the characteristic of the user from the target image, and transmit to the behavior controller the target contents list obtained by applying each of the first feature data and the second feature data to a content recommendation model.

### CROSS-REFERENCE TO RELATED APPLICATIONS

This application claims the benefit of Korean Patent Application No. 10-2023-0145798, filed on Oct. 27, 2023, which application is hereby incorporated herein by reference.

### TECHNICAL FIELD

The present disclosure relates to a guide robot and a guide robot control method.

### BACKGROUND

A guide robot may provide a user with serviceable content in a movable area. The guide robot may interact with the user to provide a function desired by the user, in the movable area.

When the movable area of the guide robot is expanded, functions required for the guide robot may also increase. At this time, a manager of the guide robot adds a new function to the guide robot to increase the robot utilization of the user. However, because it is unknown that any user will use the guide robot, adding many functions and guiding the user to select and use the function results in a problem in which unnecessary functions are exposed depending on the user and the availability of the robot decreases.

To address such a problem, there is a need to develop a technology for mapping an area where the guide robot is movable, collecting data capable of determining a user characteristic, and combining a current position of the guide robot with direction information to first provide content that the user expects from the robot.

### SUMMARY

The present disclosure relates to a guide robot, a control server, and a guide robot control method, and more particularly, relates to technologies for providing a user with content by a guide robot.

An embodiment of the present disclosure can solve the above-mentioned problems occurring in the prior art while advantages achieved by the prior art are maintained intact.

An embodiment of the present disclosure provides a guide robot for providing a user with a target contents list in which pieces of data obtained from an image recognition device and a position recognition device are reflected to selectively provide content that matches an expected behavior according to the position of a guide robot in a service area of the guide robot and the position of the user to effectively provide the user with the content, a control server, and a guide robot control method.

An embodiment of the present disclosure provides a guide robot for performing an update of pieces of content included in map information by comparing pieces of content stored in a control server with pieces of content included in the map information to fail to provide a user with unnecessary content and allow the user to increase the availability of the guide robot, a control server, and a guide robot control method.

An embodiment of the present disclosure provides a guide robot for dividing a content recommendation device for reflecting a position of the guide robot and a characteristic of a user to obtain a target contents list and a data management device for storing and managing content to efficiently distribute the amount of calculation of data, provide the user with pieces of specialized content, and provide various pieces of content depending to the position of the same guide robot to increase the utilization of the robot, a control server, and a guide robot control method.

The technical problems to be solved by an embodiment of the present disclosure are not necessarily limited to the aforementioned problems, and any other technical problems not mentioned herein can be clearly understood from the following description by those skilled in the art to which the present disclosure pertains.

According to an embodiment of the present disclosure, a guide robot may include a position recognition device that recognizes a position of the guide robot, an image recognition device that recognizes a user from a target image obtained from an image sensor, a behavior controller that transmits a request for generating a target contents list in which the position of the guide robot and a characteristic of the user are reflected to a content recommendation device, in response to a call of the user, and outputs the target contents list through an output device of the guide robot, based on receiving the target contents list from the content recommendation device, and the content recommendation device that combines the position of the guide robot with map information to generate first feature data, generates second feature data about the characteristic of the user from the target image, and transmits the target contents list obtained by applying each of the first feature data and the second feature data to a content recommendation model to the behavior controller.

In an embodiment, the position recognition device may obtain a preceding time point at which the guide robot moves, the preceding time point being close to a target time point at which the position of the guide robot is recognized, among previous time points with respect to the target time point, may combine a position of the guide robot at the preceding time point and a position of the guide robot at the target time point with the map information to obtain a direction of the guide robot at the target time point, and may transmit at least one of the position of the guide robot at the target time point or the direction of the guide robot at the target time point, or any combination thereof, to the content recommendation device.

In an embodiment, the content recommendation device may generate the first feature data including the at least one of the position of the guide robot at the target time point or the direction of the guide robot at the target time point, or the any combination thereof, may sort at least one piece of content included in map information in an order in which a straight-line distance from the position of the guide robot, the position being included in the first feature data, is close, and may apply the sorted at least one content and the first feature data to the content recommendation model to obtain a first sub-contents list including pieces of content associated with a direction opposite to the direction of the guide robot. The first sub-contents list may be included in the target contents list.

In an embodiment, the image recognition device may recognize at least one of gender information of the user, age information of the user, or face information of the user, or any combination thereof from the target image, may generate information about tracking of the face information, based on that the face information is recognized from the target image, and may transmit at least one of the recognized information or the information about the tracking, or any combination thereof to the content recommendation device. The content recommendation device may generate the second feature data including the at least one of the recognized information or the information about the tracking, or the any combination thereof, and may apply the second feature data to the content recommendation model to obtain a second sub-contents list including pieces of content in which the characteristic of the user is reflected among at least one content included in the map information. The second sub-contents list may be included in the target contents list.

In an embodiment, the guide robot may further include a data management device that performs an update of at least one piece of content included in the map information. The data management device may transmit a version of each of at least one piece of content included in the map information to a control server, may perform an update of pieces of content different from a version of content stored in the control server in the version of each of the at least one piece of content included in the map information, and may transmit an update failure notification to the behavior controller, based on the update of the pieces of content being different from the version of the content included in the map information and being stored in the control server fails more than a set, selected, or predetermined number of times.

In an embodiment, the data management device may obtain an initial position of the guide robot on the basis of a time point when power is applied to the guide robot, based on a time when the power is applied to the guide robot being less than a set, selected, or predetermined first threshold, may perform the update of the pieces of content different from the version of the content included in the map information and stored in the control server, based on the guide robot stopping at the initial position, and may transmit a request to move the guide robot to a set, selected, or predetermined waiting position to the behavior controller, based on transmitting the update failure notification to the behavior controller.

In an embodiment, the data management device may obtain a time when an idle state of the guide robot continues, based on that the guide robot being in the idle state, may perform the update of the pieces of content different from the version of the content included in the map information and stored in the control server, based on the time being greater than a set, selected, or predetermined second threshold, and may transmit a request to move the guide robot to a set, selected, or predetermined waiting position to the behavior controller, based on transmitting the update failure notification to the behavior controller.

In an embodiment, the data management device may obtain a state of charge of the guide robot, based on the guide robot being in a charge state, may perform the update of the pieces of content different from the version of the content included in the map information and stored in the control server, based on the state of charge being greater than or equal to a set, selected, or predetermined third threshold, and may transmit a request to maintain the charge of the guide robot to the behavior controller, based on transmitting the update failure notification to the behavior controller.

In an embodiment, the content recommendation device may transmit pieces of data about a graphic object in which each of pieces of content included in the target contents list is displayed as a set, selected, or predetermined area to the behavior controller, based on receiving a resource about the target contents list from a control server.

According to an embodiment of the present disclosure, a control server may include a memory storing computer-executable instructions, at least one processor that accesses the memory and executes the instructions, and a communication device that performs communication with a guide robot. The at least one processor may generate map information including a point where the guide robot is located and including pieces of content to which the guide robot is able to guide a user, may extract piece of common content capable of being provided to a user in a first area on the basis of the position where the guide robot is located and pieces of specialized content capable of being provided to the user in a second area on the basis of the point where the guide robot is located, among pieces of content stored in the control server, and may transmit the map information, the pieces of extracted common content, and the pieces of extracted specialized content to the guide robot, in response to a request of the guide robot.

In an embodiment, the at least one processor may generate a guide map on which the pieces of extracted content are displayed as a set, selected, or predetermined area, based on the map information, and may transmit the guide map to the guide robot, in response to a resource request of a content recommendation device of the guide robot.

According to an embodiment of the present disclosure, a guide robot control method may include recognizing a position of a guide robot, recognizing a user from a target image obtained from an image sensor, transmitting a request for generating a target contents list in which the position of the guide robot and a characteristic of the user are reflected to a content recommendation device, in response to a call of the user, and outputting the target contents list through an output device of the guide robot, based on receiving the target contents list from the content recommendation device, combining the position of the guide robot with map information to generate first feature data and generating second feature data about the characteristic of the user from the target image, and transmitting the target contents list obtained by applying each of the first feature data and the second feature data to a content recommendation model to a behavior controller.

In an embodiment, the recognizing of the position of the guide robot may include obtaining a preceding time point at which the guide robot moves, the preceding time point being close to a target time point at which the position of the guide robot is recognized, among previous time points with respect to the target time point, combining a position of the guide robot at the preceding time point and a position of the guide robot at the target time point with the map information to obtain a direction of the guide robot at the target time point, and transmitting at least one of the position of the guide robot at the target time point or the direction of the guide robot at the target time point, or any combination thereof, to the content recommendation device.

In an embodiment, the guide robot control method may further include generating the first feature data including the at least one of the position of the guide robot at the target time point or the direction of the guide robot at the target time point, or the any combination thereof, sorting at least one piece of content included in map information in an order in which a straight-line distance from the position of the guide robot, the position being included in the first feature data, is close, and applying the sorted at least one content and the first feature data to the content recommendation model to obtain a first sub-contents list including pieces of content associated with a direction opposite to the direction of the guide robot and included in the target contents list.

In an embodiment, the recognizing of the user may include recognizing at least one of gender information of the user, age information of the user, or face information of the user, or any combination thereof, from the target image, generating information about tracking of the face information, based on that the face information is recognized from the target image, transmitting at least one of the recognized information or the information about the tracking, or any combination thereof, to the content recommendation device, generating the second feature data including the at least one of the recognized information or the information about the tracking, or the any combination thereof, and applying the second feature data to the content recommendation model to a second sub-contents list including pieces of content in which the characteristic of the user is reflected among at least one piece of content included in the map information and included in the target contents list.

In an embodiment, the guide robot control method may further include transmitting a version of each of at least one piece of content included in the map information to a control server, performing an update of pieces of content different from a version of content stored in the control server in the version of each of the at least one piece of content included in the map information, and transmitting an update failure notification to the behavior controller, based on that the update of the pieces of content different from the version of the content included in the map information and being stored in the control server fails more than a set, selected, or predetermined number of times.

In an embodiment, the performing of the update may include obtaining an initial position of the guide robot on the basis of a time point when power is applied to the guide robot, based on that a time when the power is applied to the guide robot is less than a set, selected, or predetermined first threshold, performing the update of the pieces of content different from the version of the content included in the map information and stored in the control server, based on that the guide robot stops at the initial position, and transmitting a request to move the guide robot to a set, selected, or predetermined waiting position to the behavior controller, based on transmitting the update failure notification to the behavior controller.

In an embodiment, the performing of the update may include obtaining a time when an idle state of the guide robot continues, based on that the guide robot being in the idle state, performing the update of the pieces of content different from the version of the content included in the map information and stored in the control server, based on that the time is greater than a set, selected, or predetermined second threshold, and transmitting a request to move the guide robot to a set, selected, or predetermined waiting position to the behavior controller, based on transmitting the update failure notification to the behavior controller.

In an embodiment, the performing of the update may include obtaining a state of charge of the guide robot, based on the guide robot being in a charge state, performing the update of the pieces of content different from the version of the content included in the map information and stored in the control server, based on the state of charge being greater than or equal to a set, selected, or predetermined third threshold, and transmitting a request to maintain the charge of the guide robot to the behavior controller, based on transmitting the update failure notification to the behavior controller.

In an embodiment, the guide robot control method may further include generating the map information including a point where the guide robot is located and including pieces of content to which the guide robot is able to guide the user, extracting piece of common content capable of being provided to the user in a first area on the basis of the position where the guide robot is located and pieces of specialized content capable of being provided to the user in a second area on the basis of the point where the guide robot is located, among pieces of content stored in a control server, and transmitting the map information, the pieces of extracted common content, and the pieces of extracted specialized content to the guide robot, in response to a request of the guide robot.

### BRIEF DESCRIPTION OF THE DRAWINGS

The above and other features and advantages of the present disclosure can be more apparent from the following detailed description taken in conjunction with the accompanying drawings, in which:

FIG. 1 is a drawing illustrating a guide robot according to an embodiment of the present disclosure;

FIG. 2 is a flowchart for describing a method for outputting a target contents list, in a guide robot according to an embodiment of the present disclosure;

FIG. 3 is a drawing illustrating in detail a guide robot according to an embodiment of the present disclosure;

FIG. 4 is a drawing illustrating a process of outputting a target contents list according to a user call, in a guide robot according to an embodiment of the present disclosure;

FIG. 5 is a drawing for describing an operation of a data management device, in a guide robot according to an embodiment of the present disclosure;

FIG. 6 is a drawing for describing an operation of a behavior controller, in a guide robot according to an embodiment of the present disclosure;

FIG. 7 is a drawing for describing operations of an image recognition device and a position recognition device, in a guide robot according to an embodiment of the present disclosure;

FIGS. 8A, 8B, and 8C are flowcharts for describing an operation of performing an update of pieces of contents in a data management device, in a guide robot according to an embodiment of the present disclosure;

FIG. 9 is a flowchart for describing a method for outputting a target contents list, in a guide robot according to an embodiment of the present disclosure;

FIG. 10 is a drawing illustrating a control server according to an embodiment of the present disclosure;

FIG. 11 is a drawing illustrating a method for transmitting map information and a contents list to a guide robot, in a control server according to an embodiment of the present disclosure;

FIG. 12 is a drawing illustrating a guide map generated based on map information, in a control server according to an embodiment of the present disclosure;

FIG. 13 is a drawing for describing a source code of a guide map according to an embodiment of the present disclosure; and

FIG. 14 is a drawing illustrating a computing system associated with a guide robot, a control server, and a guide robot control method according to an embodiment of the present disclosure.

With regard to the description of drawings, same or similar denotations may be used for same or similar components.

### DETAILED DESCRIPTION OF ILLUSTRATIVE EMBODIMENTS

Hereinafter, some embodiments of the present disclosure will be described in detail with reference to the example drawings. In adding the reference numerals to the components of each drawing, it can be noted that the identical component can be designated by the identical numerals even when they are displayed on other drawings. In addition, a detailed description of well-known features or functions can be omitted to not unnecessarily obscure the gist of the present disclosure. Hereinafter, various embodiments of the present disclosure may be described with reference to the accompanying drawings. However, it can be understood that this is not intended to necessarily limit the present disclosure to specific implementation forms and includes various modifications, equivalents, and/or alternatives of embodiments of the present disclosure. Regarding the description of drawings, similar components may be marked by similar reference numerals.

In describing components of example embodiments of the present disclosure, the terms “first,” “second,” “A,” “B,” “(a),” “(b),” and the like, may be used herein. These terms can be used merely to distinguish one component from another component, but do not necessarily limit the corresponding components irrespective of the order or priority of the corresponding components. Furthermore, unless otherwise defined, all terms including technical and scientific terms used herein can have the same meaning as being generally understood by those skilled in the art to which the present disclosure pertains. Such terms as those defined in a generally used dictionary can be interpreted as having meanings equal to the contextual meanings in the relevant field of art. For example, the terms, such as “first,” “second,” “1st,” “2nd,” or the like, used in the present disclosure may be used to refer to various components regardless of the order and/or the priority and to distinguish one component from another component, but do not necessarily limit the components. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have,” “may have,” “include” and “comprise,” or “may include” and “may comprise” indicate existence of corresponding features (e.g., components such as numeric values, functions, operations, or parts), but do not exclude presence of additional features.

It can be understood that when a component (e.g., a component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it can be understood that there is no intervening component (e.g., a third component).

According to the situation, the expression “configured to” used in the present disclosure may be used exchangeably with, for example, the expression “suitable for,” “having the capacity to,” “designed to,” “adapted to,” “made to,” or “capable of.”

The term “configured to” does not mean necessarily only “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs which store a dedicated processor (e.g., an embedded processor) for performing a corresponding operation or a memory device. Terms used in the present disclosure can be used to only describe specified embodiments and are not necessarily intended to limit the scope of another embodiment. The terms of a singular form may include plural forms unless the context clearly indicates otherwise. All the terms used herein, which include technical or scientific terms, may have the same meaning that is generally understood by a person skilled in the art described in the present disclosure. It can be further understood that terms, which are defined in a dictionary and commonly used, can also be interpreted as is customary in the relevant related art. In some cases, even though terms are terms which are defined in the specification, they may not be interpreted to exclude embodiments of the present disclosure.

In the present disclosure, the expressions “A or B,” “at least one of A or/and B,” or “one or more of A or/and B,” and the like, may include any and all combinations of the associated listed items. For example, the term “A or B,” “at least one of A and B,” or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B,” “at least one of A and B,” “at least one of A or B,” “A, B, or C,” “at least one of A, B, and C,” “at least one of A, B, or C,” and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A,” “B,” or “C,” or “AB” or “ABC,” which is a combination thereof, for example.

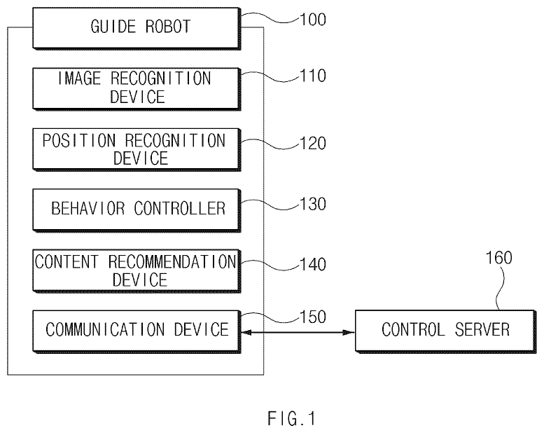

Hereinafter, embodiments of the present disclosure will be described in detail with reference to FIGS. 1 to 14.

FIG. 1 is a drawing illustrating a guide robot according to an embodiment of the present disclosure.

A guide robot 100 according to an embodiment may include an image recognition device 110, a position recognition device 120, a behavior controller 130, a content recommendation device 140, and a communication device 150 that assists in performing communication between the guide robot 100 and a control server 160, any or all of which may be in plural. The guide robot 100 according to an embodiment may not include at least one of the components or may additionally include another component.

The guide robot 100 may indicate a robot that outputs a target contents list in which a position of the guide robot 100 and a characteristic of a user are reflected, in response to a call of the user. For example, the guide robot 100 may recognize the user from a target image obtained from an image sensor, by using the image recognition device 110. The guide robot 100 may recognize a position of the guide robot 100 by using the position recognition device 120. The guide robot 100 may transmit data (e.g., a position of the user or the guide robot 100) recognized by each of the image recognition device 110 and the position recognition device 120 to the behavior controller 130 and the content recommendation device 140.

The guide robot 100 may perform the following operations to output the target contents list responding to the call of the user. For example, the guide robot 100 may transmit a request for generating the target contents list in which the position of the guide robot 100 and the characteristic of the user are reflected to the content recommendation device 140 by using the behavior controller 130.

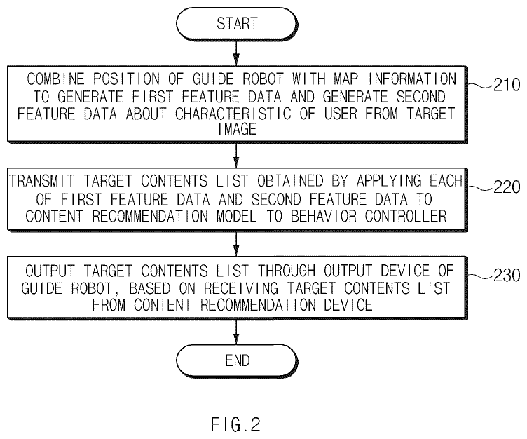

The guide robot 100 may combine the position of the guide robot 100 with map information to generate first feature data and may generate second feature data about the characteristic of the user from the target image, by using the content recommendation device 140. The guide robot 100 may transmit to the behavior controller 130 the target contents list obtained by applying each of the first feature data and the second feature data to a content recommendation model. The guide robot 100 may output the target contents list through its output device by using the behavior controller 130. A detailed description of the content recommendation model that receives the first feature data and the second feature data and generates the target contents list will be given below with reference to FIG. 2, for example.

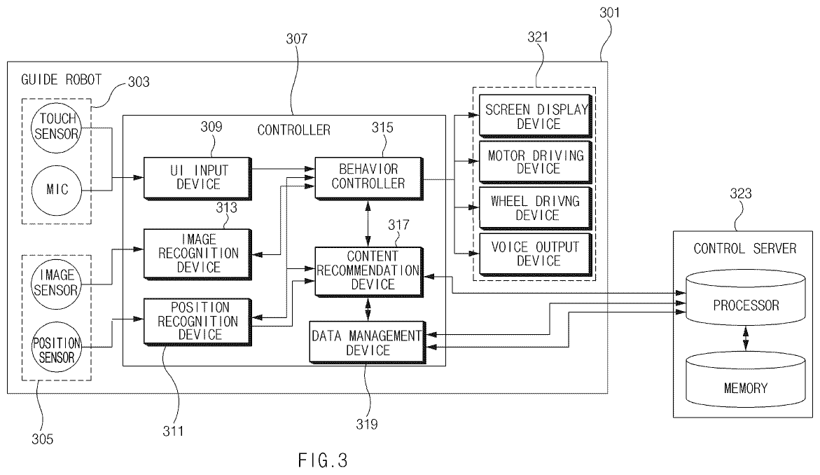

For reference, the guide robot 100 may perform all operations performed by the image recognition device 110, the position recognition device 120, the behavior controller 130, and the content recommendation device 140. Therefore, for convenience of description in the specification, the operations performed by the image recognition device 110, the position recognition device 120, the behavior controller 130, and the content recommendation device 140 can be mainly described as operations performed by the guide robot 100. Furthermore, a detailed description of the image recognition device 110, the position recognition device 120, the behavior controller 130, and the content recommendation device 140 will be given below with reference to FIG. 3, for example.

FIG. 2 is a flowchart for describing a method for outputting a target contents list using a guide robot according to an embodiment of the present disclosure.

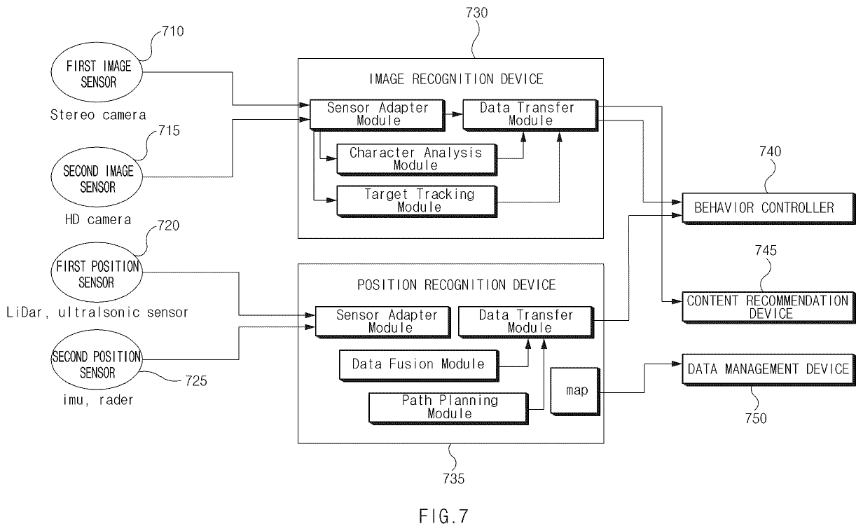

In operation 210, a guide robot (e.g., a guide robot 100 of FIG. 1) according to an embodiment may combine a position of the guide robot with map information to generate first feature data and may generate second feature data about a characteristic of a user from a target image. For example, the first feature data may be feature data about the guide robot, which may include pieces of information about the position of the guide robot and a direction the guide robot is facing. Particularly, the direction that the guide robot is facing may be obtained based on the position of the guide robot and the map information. A detailed description of the direction that the guide robot is facing will be given below with reference to FIG. 7, for example. The second feature data may be feature data about the user, which may include pieces of information recognized from an image obtained by an image recognition device of the guide robot and data about tracking about a user face. A detailed description of it will be given below with reference to FIG. 7, for example.

In operation 220, the guide robot may transmit to a behavior controller a target contents list obtained by applying each of the first feature data and the second feature data to a content recommendation model.

For example, the content recommendation model may include a neural network model. In detail, at least one of the guide robot, a control server (e.g., a control server 160 of FIG. 1), or the other learning devices, may train the content recommendation model. The neural network may include a plurality of layers. Each layer may include a plurality of nodes. A node may include a node value determined based on an activation function. A node of any layer may be connected with a node (e.g., another node) of another layer through a link (e.g., a connection edge) with a connection weight. The node value of the node may be propagated to other nodes through the link. In an inference operation of the neural network, node values may be forward propagated in the direction of a next layer from a previous layer.

Illustratively, the forward propagation calculation in the content recommendation model may indicate calculation of propagating a node value based on input data, in the direction facing the output layer from the input layer of the content recommendation model. In other words, a node value of the node may be propagated (e.g., forward propagated) to a node (e.g., a next node) of a next layer connected with the node through the connection edge. For example, the node may receive a value weighted by the connection weight from a previous node (e.g., a plurality of nodes) connected through the connection edge.

The node value of the node may be determined based on applying an activation function to the sum (e.g., weighted sum) of weighted values received from previous nodes. The parameter of the neural network may illustratively include the above-mentioned connection weight. The parameter of the neural network may be updated to be changed in a direction in which an objective function value, which will be described below, is targeted (e.g., a direction in which a loss is minimized).

The trained content recommendation model may indicate a model trained by using machine learning and may be a trained machine learning model that outputs a training output (e.g., a target contents list) from or based on a training input (e.g., the first feature data and the second feature data).

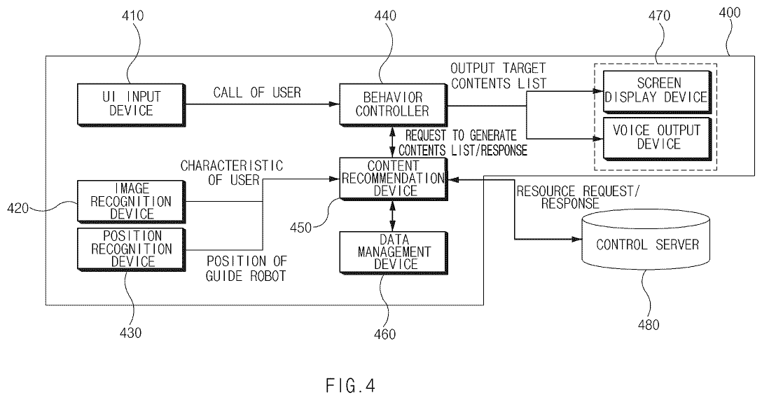

However, the training input and the training output are not necessarily limited thereto. For example, the trained content recommendation model may obtain a first sub-contents list including pieces of content associated with a direction opposite to the direction of the guide robot from the pieces of sorted content and the first feature data. For reference, a detailed description of the pieces of sorted content will be given below with reference to FIG. 4, for example.

Similarly, the trained content recommendation model may obtain a second sub-contents list including pieces of content in which the characteristic of the user is reflected, from the second feature data.

The guide robot may combine the first sub-contents list and the second sub-contents list, which are obtained by the content recommendation model, on the basis of a set, selected, or predetermined priority to obtain the target contents list. For example, when the set, selected, or predetermined priority is about the position of the guide robot, the guide robot may obtain a target contents list with which the first sub-contents list that takes precedence over the second sub-contents list. Furthermore, when the set, selected, or predetermined priority is about the characteristic of the user, the guide robot may obtain a target contents list with which the second sub-contents list takes precedence over the first sub-contents list.

The machine learning model (e.g., the trained content recommendation model) may be generated by using machine learning. A learning algorithm may include, for example, but is not necessarily limited to, supervised learning, unsupervised learning, semi-supervised learning, reinforcement learning, or any combination thereof, for example.

The trained machine learning model may include a plurality of artificial neural network layers. In detail, an artificial neural network may be, but is not limited to, at least one of a deep neural network (DNN), a convolutional neural network (CNN), a U-net for image segmentation (U-net), a recurrent neural network (RNN), a restricted Boltzmann machine (RBM), a deep belief network (DBN), a bidirectional recurrent deep neural network (BRDNN), or deep Q-networks, or any combination thereof, for example.

For the supervised learning, the above-mentioned machine learning model may be trained based on training data including a pair of a training input and a training output mapped to the training input. For example, the machine learning model may be trained to output a training output from or based on a training input. The machine learning model that is being trained may generate a temporary output in response to the training input and may be trained such that a loss between the temporary output and the training output (e.g., correct answer data as a training target) is minimized. A parameter of the machine learning model during a learning process (e.g., a connection weight between nodes/layers in the neural network) may be updated according to a loss. Such learning may be performed in the guide robot itself in which the machine learning model is performed or may be performed by using a separate server. The machine learning model, the training of which is completed, (e.g., the trained content recommendation model) may be stored in a memory of the guide robot.

In operation 230, the guide robot may output the target contents list through an output device of the guide robot, based on receiving the target contents list from a content recommendation device. For example, the guide robot may transmit a request for generating the target contents list in which the position of the guide robot and the characteristic of the user are reflected to the content recommendation device, in response to a call of the user, by using a behavior controller. The guide robot may output the target contents list through the output device, based on receiving the target contents list from the content recommendation device.

FIG. 3 is a drawing illustrating in detail a guide robot according to an embodiment of the present disclosure.

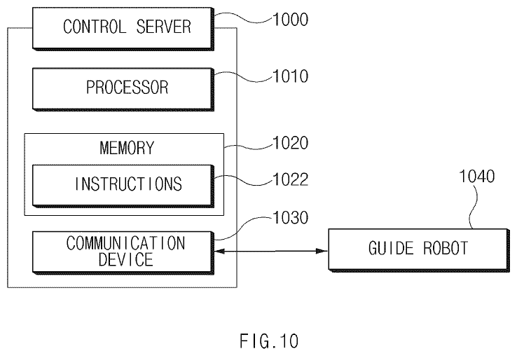

A guide robot 301 according to an embodiment may include an input device 303, a sensor 305, a controller 307, and an output device 321. A control server 323 according to an embodiment may include a processor and a memory. For reference, a detailed description of the control server 323 will be given below with reference to FIG. 10, for example.

The input device 303 may deliver, for example, a command or data, input from a user or another external device, to the controller 307. For example, the input device 303 may include a touch sensor and a microphone. The input device 303 may receive a content extraction response from the user or the external device by using the touch sensor. Furthermore, the input device 303 may receive the content extraction response from a sound generated by the user or a sound generated from the external device, by using the microphone.

The sensor 305 may recognize, for example, information about a position of the guide robot 301 or may recognize a surrounding environment of the guide robot 301 and the user. For example, the sensor 305 may include an image sensor and a position sensor.

The controller 307 may obtain a target contents list based on a command or data received by the input device 303 and the sensor 305 and may transmit the obtained target contents list to the output device 321. For example, the controller 307 may include a user input (UI) input device 309, a position recognition device 311, an image recognition device 313, a behavior controller 315, a content recommendation device 317, and a data management device 319.

The UI input device 309 may receive a command or data input through the input device 303. The UI input device 309 may deliver the received command or data to the behavior controller 315.

The position recognition device 311 may receive information about the position of the guide robot 301, which is recognized or measured by the position sensor included in the sensor 305. The position recognition device 311 may obtain a direction of the guide robot 301, based on a target time point at which the position of the guide robot 301 is recognized/measured and a preceding time point. The position recognition device 311 may transmit at least one of a position of the guide robot 301 at the target time point or a direction of the guide robot 301 at the target time point, or any combination thereof, to each of the behavior controller 315 and the content recommendation device 317.

The image recognition device 313 may receive information about the surrounding environment or the user, which is recognized by the image sensor included in the sensor 305. The image recognition device 313 may recognize and/or generate gender information of the user, age information of the user, face information of the user, or information about tracking of the face information from the target image obtained from the image sensor. The image recognition device 313 may transmit at least one of the recognized information or the information about the tracking, or any combination thereof, to each of the behavior controller 315 and the content recommendation device 317.

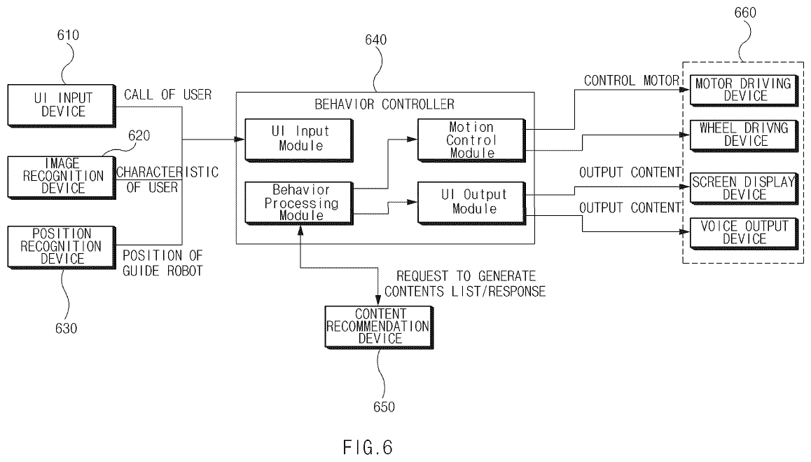

The behavior controller 315 may request the content recommendation device 317 to generate a target contents list or may transmit the pieces of received information to the output device 321, based on the pieces of information received from the UI input device 309, the position recognition device 311, and the image recognition device 313. For reference, a detailed description of the behavior controller 315 will be given below with reference to FIG. 6, for example.

The content recommendation device 317 may obtain, for example, a target contents list, based on first feature data generated by combining a position of the guide robot 301 with map information and second feature data about a characteristic of the user, which is generated from the target image. In other words, the content recommendation device 317 may be a component for obtaining the target contents list to provide and/or recommend pieces of specialized content to the user.

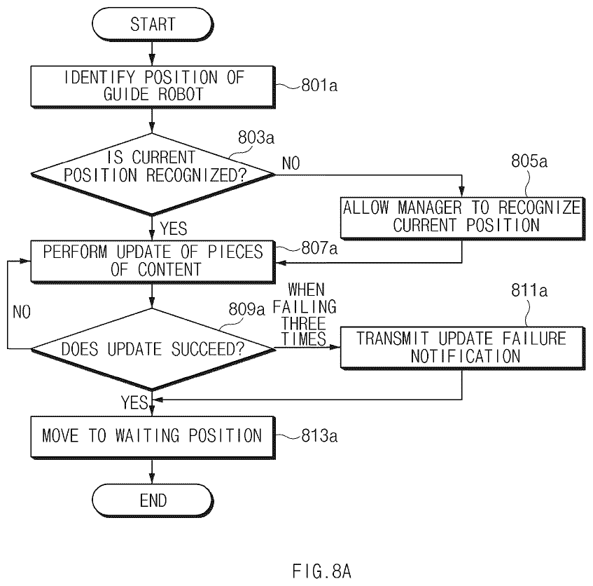

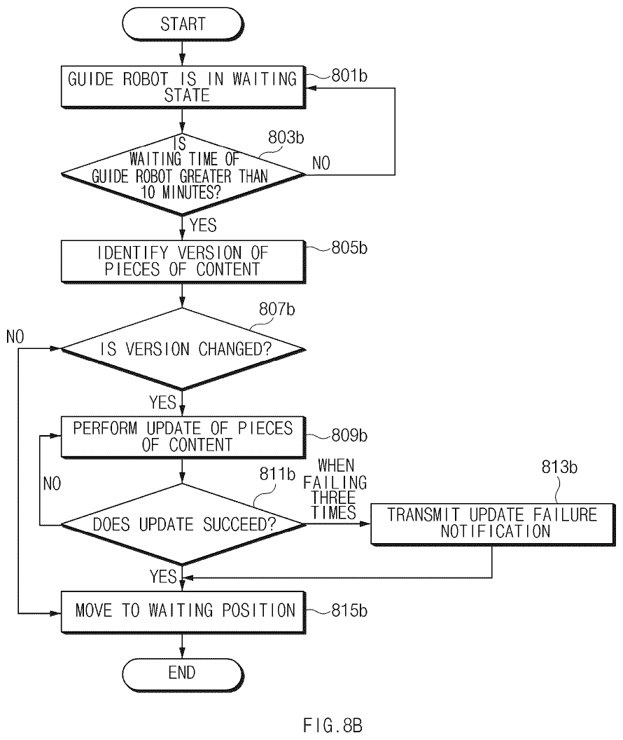

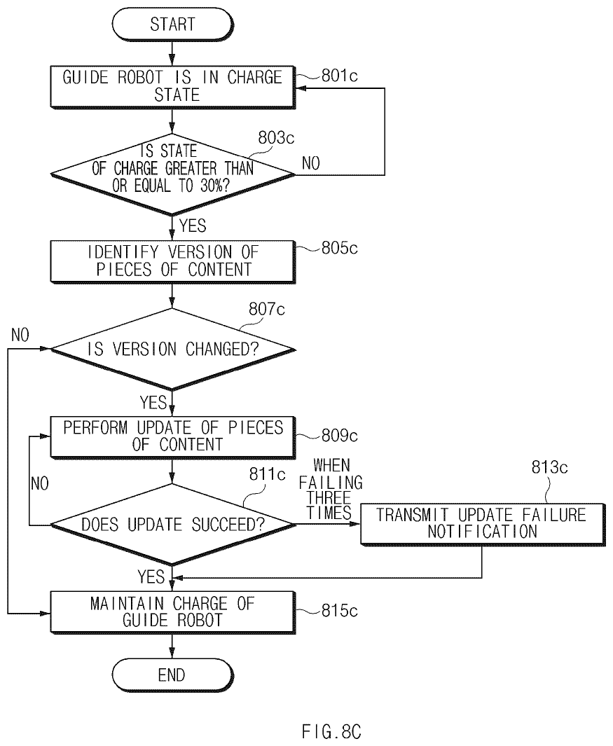

The data management device 319 may be, for example, a component for managing pieces of necessary data, such that the content recommendation device 317 generates the target contents list or the behavior controller 315 transmits a result (e.g., the target contents list or a map on which the target contents list is displayed) to the output device 321. Particularly, the data management device 319 may perform an update of pieces of data stored in the guide robot 301 through communication with the control server 323. The method for performing the update of the pieces of data in the data management device 319 will be described in detail below with reference to FIGS. 8A to 8C, for example.

The output device 321 may include a screen display device, a motor driving device, a wheel driving device, and a voice output device. The output device 321 may output data and information, which are received from other component(s) of the guide robot 301, to the user or another external device. Particularly, the screen display device may include, for example, a liquid crystal display (LCD), a light-emitting diode (LED) display, an organic LED (OLED) display, a microelectromechanical systems (MEMS) display, or an electronic paper display. The screen display device may display various pieces of content (e.g., content included in the target contents list) to the user.

FIG. 4 is a drawing illustrating a process of outputting a target contents list according to a user call, in a guide robot according to an embodiment of the present disclosure.

A guide robot 400 according to an embodiment may include a UI input device 410, an image recognition device 420, a position recognition device 430, a behavior controller 440, a content recommendation device 450, a data management device 460, and an output device 470.

The behavior controller 440 may deliver a request to generate a contents list to the content recommendation device 450, based on receiving a call of a user from the UI input device 410.

The content recommendation device 450 may generate first feature data including at least one of a position of the guide robot 400 at a target time point or a direction of the guide robot 400 at the target time point, or any combination thereof. The position of the guide robot 400 may be a position of the guide robot 400, which is recognized by the position recognition device 430.

The content recommendation device 450 may sort at least one piece of content included in map information in an order in which a straight-line distance from the position of the guide robot 400, which is included in the first feature data, is close. For example, the content recommendation device 450 may obtain pieces of content sorted in an order in which at least one piece of content included in the map information is close to the position of the guide robot 400, by using the above-mentioned operation.

The content recommendation device 450 may apply the pieces of sorted content and the first feature data to a content recommendation model to obtain a first sub-contents list including pieces of content associated with a direction opposite to the direction of the guide robot 400. For example, the first sub-contents list may be included in the target contents list. In detail, the first sub-contents list may include pieces of content which may be close to the position of the guide robot 400 and may be provided by the guide robot 400 in the direction opposite to the direction of the guide robot 400 among the pieces of sorted content.

The content recommendation device 450 may generate second feature data including at least one of recognized information or data about tracking, or any combination thereof. The recognized information and the data about the tracking may be data generated by the image recognition device 420.

The content recommendation device 450 may apply the second feature data to the content recommendation model to obtain a second sub-contents list including pieces of content in which a characteristic of the user is reflected among the at least one piece of content included in the map information. For example, the second sub-contents list may be different from the first sub-contents list and may be included in the target contents list. In detail, the second sub-contents list may include pieces of content which may be provided to the recognized user and/or may be recommended to the recognized user among the at least one content included in the map information.

The content recommendation device 450 may generate the target contents list, based on the first sub-contents list and the second sub-contents list. For example, the content recommendation device 450 may request a resource from a control server 480, based on that the target contents list is generated. The resource may indicate pieces of data capable of outputting pieces of content included in the target contents list as a graphic object through the output device 470. Thereafter, the content recommendation device 450 may deliver the target contents list and the resource about it together in response to the request of the behavior controller 440 to generate the contents list.

The behavior controller 440 may output the target contents list through the output device 470, based on receiving the target contents list from the content recommendation device 450. As a result, the behavior controller 440 may provide the user with pieces of specialized content (pieces of content included in the target contents list).

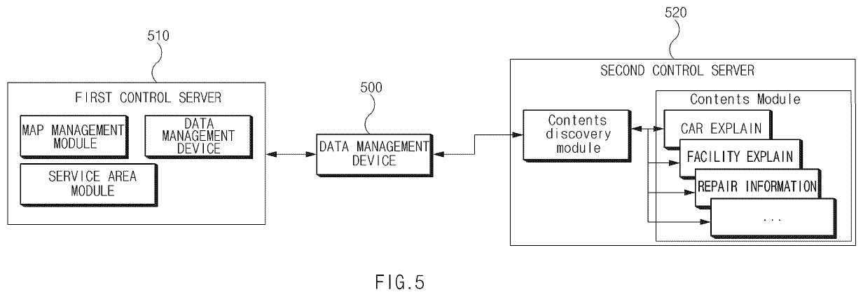

FIG. 5 is a drawing for describing an operation of a data management device in a guide robot according to an embodiment of the present disclosure.

A guide robot (e.g., a guide robot 100 of FIG. 1) according to an embodiment may include a data management device 500. For example, the data management device 500 may perform an update of at least one piece of content included in map information. The map information may be map information stored in the guide robot, which may be data constituting a map to be provided to a user together with pieces of content.

The data management device 500 may transmit a version of each of the at least content included in the map information to a second control server 520 among control servers. The data management device 500 may perform an update of pieces of content different from the version of the content stored in the second control server 520 in the version of each of the at least one content included in the map information. The data management device 500 may transmit an update failure notification to a behavior controller, based on that the update of the pieces of content different from the version of the content included in the map information and attempted storing in the second control server 520 failing more than a set, selected, or predetermined number of times. A detailed description of the update of the at least one content included in the map information will be described below with reference to FIGS. 8A to 8C, for example.

A control server (e.g., a control server 160 of FIG. 1) according to an embodiment may include a first control server 510 and the second control server 520. For example, the first control server 510 may be a server that manages the guide robot, which may indicate a server that manages the map information stored in the guide robot or manages the at least one content included in the map information. The second control server 520 may be a server that provides content, which may indicate a server that provides pieces of contents corresponding to properties (e.g., a version, hardware specifications, or the like) of the guide robot in response to the request of the data management device 500.

The first control server 510 may include a map management module, a robot setting module, and a service area module. For example, the map management module may indicate a module that manages the map information stored in the guide robot. The robot setting module may indicate a module that manages a setting of the guide robot. The service area module may indicate a module that manages pieces of content to be provided to the user together with the map information. In other words, the pieces of content may be provided to the user in an area where the guide robot is movable. Operations in which the pieces of content are provided to the user may be understood as providing a service to the user in the guide robot.

The second control server 520 may include a contents discovery module and a contents module. For example, the contents discovery module may indicate a module that discovers pieces of content stored in the second control server 520, based on receiving a request for an update of pieces of content from the data management device 500. The contents module may include at least one piece of content. In detail, the contents module may include content about car explain, content about facility explain, and content about repair information. The pieces of content included in the contents module may be delivered to the guide robot by the data management device 500.

FIG. 6 is a drawing for describing an operation of a behavior controller in a guide robot according to an embodiment of the present disclosure.

In operation 210 of FIG. 2, a guide robot (e.g., a guide robot 100 of FIG. 1) according to an embodiment may include a UI input device 610, an image recognition device 620, a position recognition device 630, a behavior controller 640, a content recommendation device 650, and an output device 660. Because the descriptions of the UI input device 610, the image recognition device 620, the position recognition device 630, and the output device 660 can be the same as the above-mentioned details, they will be omitted in the description of FIG. 6. Regarding FIG. 6, details about an operation of the behavior controller 640 will be mainly described.

The behavior controller 640 may include a UI input module, a behavior processing module, a UI output module, and a motion control module. For example, the UI input module may receive data and/or information delivered from the UI input device 610, the image recognition device 620, and the position recognition device 630.

The behavior processing module may deliver a request for generating a contents list to the content recommendation device 650. Furthermore, the behavior processing module may generate behaviors of the guide robot for pieces of content included in a target contents list received from the content recommendation device 650. For example, for content about vehicle guidance, the behavior processing module may generate a behavior for the guide robot to guide the user to the vehicle and a behavior for providing content about the vehicle guidance. As a result, the behavior processing module may deliver the generated behaviors to each of the UI output module and the motion control module.

The motion control module may control to drive at least one of a neck of the guide robot, arms of the guide robot, or wheels of the guide robot, or any combination thereof. The UI output module may output pieces of content included in the target contents list to the user through a screen display device and a voice output device mounted on the guide robot.

The UI output module may deliver a resource about the target contents list to the screen display device, in conjunction with that the UI output module outputs pieces of content included in the target contents list through the screen display device. For example, the content recommendation device 650 may transmit pieces of data about a graphic object in which each of the pieces of content included in the target contents list is displayed as a set, selected, or predetermined area to the behavior controller 640, based on receiving the resource about the target contents list from the control server. Particularly, the content recommendation device 650 may deliver pieces of data about the graphic object to the behavior processing module of the behavior controller 640, and the behavior processing module may deliver the pieces of transmitted data about the graphic object to the UI output module.

FIG. 7 is a drawing for describing operations of an image recognition device and a position recognition device in a guide robot according to an embodiment of the present disclosure.

In operation 210 of FIG. 2, a guide robot (e.g., a guide robot 100 of FIG. 1) according to an embodiment may include an image recognition device 730, a position recognition device 735, a behavior controller 740, a content recommendation device 745, and a data management device 750.

The image recognition device 730 may include a sensor adapter module, a data transfer module, a character analysis module, and a target tracking module. For example, the sensor adapter module may indicate a module that converts data obtained from a first image sensor 710 or a second image sensor 715 to be available in a module included in the image recognition device 730. The character analysis module may analyze data (e.g., a target image) received from the sensor adapter module and may discover an object. In detail, the character analysis module may recognize at least one of gender information of a user, age information of the user, face information of the user, or any combination thereof, from a target image.

When recognizing a person from the target image, the target tracking module may generate tracking information for controlling the neck of the guide robot. For example, the target tracking module may generate data about tracking of the face information, based on the face information being recognized from the target image. The data about the tracking may indicate data for tracking the face information recognized from the target image.

The data transfer module may be a module that publishes pieces of processed and/or generated data (e.g., data about tracking) to other components of the guide robot. The data transfer module may transmit at least one of the recognized information or the data about the tracking, or any combination thereof, to the behavior controller 740 and the content recommendation device 745.

The position recognition device 735 may include a sensor adapter module, a data fusion module, a path planning module, and a data transfer module. The sensor adapter module may indicate a module that converts data obtained from a first position sensor 720 or a second position sensor 725 to be available in a module included in the position recognition device 735. The data fusion module may indicate a module for obtaining direction information of the guide robot, based on a map according to map information stored in the guide robot. The path planning module may indicate a module that generates a path along which the guide robot will move, based on the obtained information. The data transfer module may be a module that publishes the pieces of processed and/or generated data to other components of the guide robot.

The data fusion module may obtain a preceding time point at which the guide robot moves, which is close to a target time point at which the position of the guide robot is recognized, among previous time points with respect to the target time point. The data fusion module may combine a position of the guide robot at the preceding time point and a position of the guide robot at the target time point with map information to obtain a direction of the guide robot at the target time point. The data transfer module may transmit at least one of the position of the guide robot at the target time point or the direction of the guide robot at the target time point, or any combination thereof, to the behavior controller 740, the content recommendation device 745, and the data management device 750.

FIGS. 8A to 8C are flowcharts for describing an operation of performing an update of pieces of contents in a data management device in a guide robot according to an embodiment of the present disclosure.

Referring to FIGS. 8A to 8C, a guide robot (e.g., a guide robot 100 of FIG. 1) according to an embodiment may perform an update of pieces of content by using a data management device.

Referring to FIG. 8A, in operation 801a, the data management device may identify and obtain a position of the guide robot. For example, the data management device may identify and obtain the position of the guide robot, based on a position obtained from a position recognition device.

In operation 803a, the data management device may determine whether it is able to recognize a current position of the guide robot. For example, the data management device may obtain an initial position and/or a current position of the guide robot based on a time point when power is applied to the guide robot, based on that a time when the power is applied to the guide robot being less than a set, selected, or predetermined second threshold. However, it is not necessarily limited thereto. In operation 803a, the data management device may obtain a direction of the guide robot.

In operation 805a, the data management device may perform an operation of allowing a manager to recognize the current position of the guide robot, based on not recognizing the current position of the guide robot.

In operation 807a, the data management device may perform an update of pieces of content, based on recognizing the current position of the guide robot. For example, the data management device may perform an update of pieces of content different from a version of content included in map information and stored in a control server, based on the guide robot stopping at the initial position.

In operation 809a, the data management device may determine whether the update succeeds. For example, when the update of the pieces of content fails, the data management device may perform operation 807a again. When the above-mentioned operation fails three times, in operation 811a, the data management device may transmit an update failure notification to a behavior controller. When the update of the pieces of content fails, the guide robot may perform a content output operation, using a last version (or a latest version) of each of pieces of content stored in the guide robot.

In operation 813a, the data management device may transmit a request to move the guide robot to a set, selected, or predetermined waiting position to the behavior controller, based on ending the update.

Referring to FIG. 8B, in operation 801b, the data management device may identify whether the guide robot is in a waiting state. For example, in operation 803b, the data management device may identify the waiting state of the guide robot based on whether the waiting time of the guide robot is greater than 10 minutes. The data management device may obtain a time when an idle state of the guide robot continues, based on the guide robot is in the idle state.

In operation 805b, the data management device may identify a version of pieces of content included in map information, based on the time being greater than a set, selected, or predetermined first threshold (e.g., 10 minutes). In operations 807b and 809b, the data management device may perform an update of pieces of content different from a version of content included in the map information and stored in the control server. Operations 811b and 813b may be the same as details described with reference to FIG. 8A.

In operation 815b, the data management device may transmit a request to move the guide robot to the set, selected, or predetermined waiting position to the behavior controller, based on transmitting the update failure notification to the behavior controller.

Referring to FIG. 8C, in operation 801c, the data management device may identify whether the guide robot is in a charge state. In operation 803c, the data management device may obtain a state of charge of the guide robot, based on the state of the guide robot being the charge state, and may perform the following operations, based on that the state of charge being greater than or equal to a set, selected, or predetermined third threshold (e.g., 30%).

In operation 805c, the data management device may identify a version of pieces of content included in the map information. In operations 807c and 809c, the data management device may perform an update of pieces of content different from a version of content included in the map information and stored in the control server. Operations 811c and 813c may be the same as details described with reference to FIG. 8A.

In operation 815c, the data management device may transmit a request to maintain the charge of the guide robot to the behavior controller, based on transmitting the update failure notification to the behavior controller.

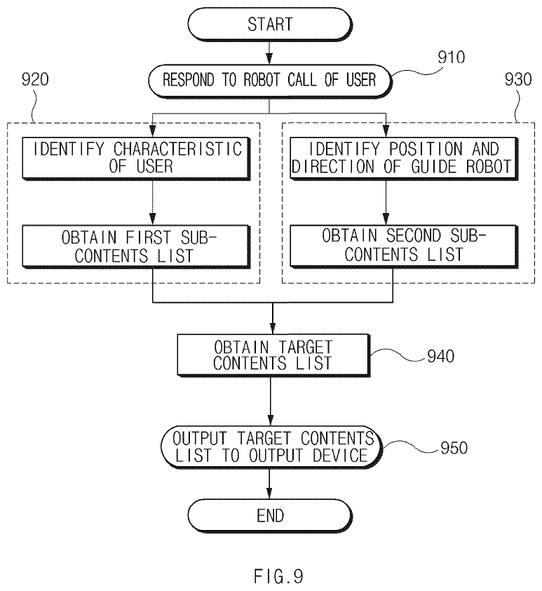

FIG. 9 is a flowchart for describing a method for outputting a target contents list by a guide robot according to an embodiment of the present disclosure.

In operation 910, a guide robot (e.g., a guide robot 100 of FIG. 1) according to an embodiment may respond to a robot call of a user. The guide robot may perform the following operations in response to the robot call of the user.

In operation 920, the guide robot may obtain a first sub-contents list. For example, the guide robot may identify a user characteristic to generate first feature data associated with the user characteristic, thus obtaining the first sub-contents list.

In operation 930, the guide robot may obtain a second sub-contents list. For example, the guide robot may identify a position and a direction of the guide robot to generate second feature data associated with the position and the direction of the guide robot, thus obtaining the second sub-contents list.

In operation 940, the guide robot may obtain a target contents list. For example, the guide robot may apply each of the first feature data and the second feature data to a content recommendation model to obtain the target contents list. However, as described above, the method for obtaining the target contents list is not necessarily limited thereto.

In operation 950, the guide robot may output the target contents list through its output device. The guide robot may output the target contents list, thus providing the user with pieces of content included in the target contents list.

FIG. 10 is a drawing illustrating a control server according to an embodiment of the present disclosure.

A control server 1000 according to an embodiment may include a processor 1010, a memory 1020 including code/instructions 1022, and a communication device 1030, any and all of which may be in plural. For example, the control server 1000 may be a server which controls a guide robot 1040, which may be a server that delivers map information including pieces of content to the guide robot 1040 or delivers only pieces of content to the guide robot 1040.

The control server 1000 may generate map information that includes a point at which the guide robot 1040 is located and includes pieces of content to which the guide robot 1040 is able to guide a user. The control server 1000 may extract pieces of common content capable of being provided to the user in a first area (e.g., an area where the guide robot 1040 is movable and the other areas) on the basis of the point at which the guide robot 1040 is located and pieces of specialized content capable of being provided to the user in a second area (e.g., an area where the guide robot 1040 is movable) on the basis of the point at which the guide robot 1040 is located, among pieces of content stored in the control server 1000. The control server 1000 may transmit the map information, the pieces of extracted common content, and the pieces of extracted specialized content to the guide robot 1040 through the communication device 1030, in response to the request of the guide robot 1040.

The processor 1010 may execute software and may control at least one other component (e.g., a hardware or software component) connected with the processor 1010. In addition, the processor 1010 may perform a variety of data processing or calculation. For example, the processor 1010 may store the map information, the pieces of extracted common content, and the pieces of extracted specialized content in the memory 1020.

For reference, the processor 1010 may perform all operations performed by the control server 1000. Therefore, for convenience of description in the specification, the operation performed by the control server 1000 is mainly described as an operation performed by the processor 1010.

Furthermore, for convenience of description in the specification, the processor 1010 is mainly described as, but not necessarily limited to, one processor. For example, the control server 1000 may include one or more processors.

The memory 1020 may temporarily and/or permanently store various pieces of data and/or information required for operations performed by the control server 1000. For example, the memory 1020 may store the map information, the pieces of extracted common content, and the pieces of extracted specialized content.

The communication device 1030 may assist in performing communication between the control server 1000 and the guide robot 1040. For example, the communication device 1030 may include one or more components for performing communication between the control server 1000 and the guide robot 1040. For example, the communication device 1030 may include a short range wireless communication unit, a microphone, or the like. A short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like, for example.

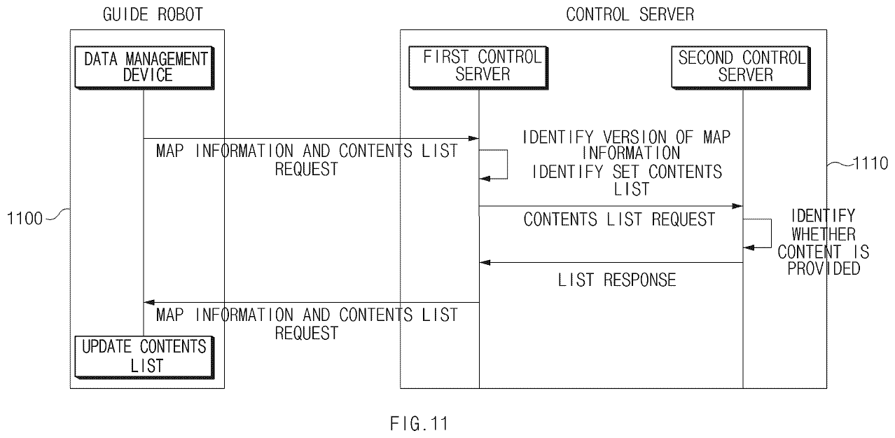

FIG. 11 is a drawing illustrating a method for transmitting map information and a contents list to a guide robot, in a control server according to an embodiment of the present disclosure.

A guide robot 1100 according to an embodiment may include a data management device that requests map information and a contents list from a control server 1110. For example, the data management device may request the map information and the contents list from a first control server included in the control server 1110. The first control server may identify a version of the requested map information and may identify a set contents list, in response to the request of the data management device. The map information may refer to information about a map that is output together with a target contents list to the user by the guide robot 1100. As an area where the guide robot 1100 is movable is mapped, the map information may be stored as a file. Furthermore, the contents list may include information about pieces of content stored in the guide robot 1100.

According to an embodiment, the control server 1110 may include a first control server and a second control server. As described above with reference to FIG. 5, the first control server and the second control server may perform the same operation as a first control server (e.g., a first control server 510 of FIG. 5) and a second control server (e.g., a second control server 520 of FIG. 5), for example.

The first control server may request a contents list from the second control server, based on identifying the version of the requested map information and the set contents list. The second control server may deliver the contents list to the first control server in response to the request of the first control server. The first control server may deliver the contents list to the guide robot 1100, based on receiving the contents list from the second control server. For example, the first control server may deliver a guide map on which pieces of extracted common content and pieces of extracted specialized content among pieces of content stored in the control server 1110 are displayed as a set, selected, or predetermined area and a contents list associated with the guide map to the data management device.

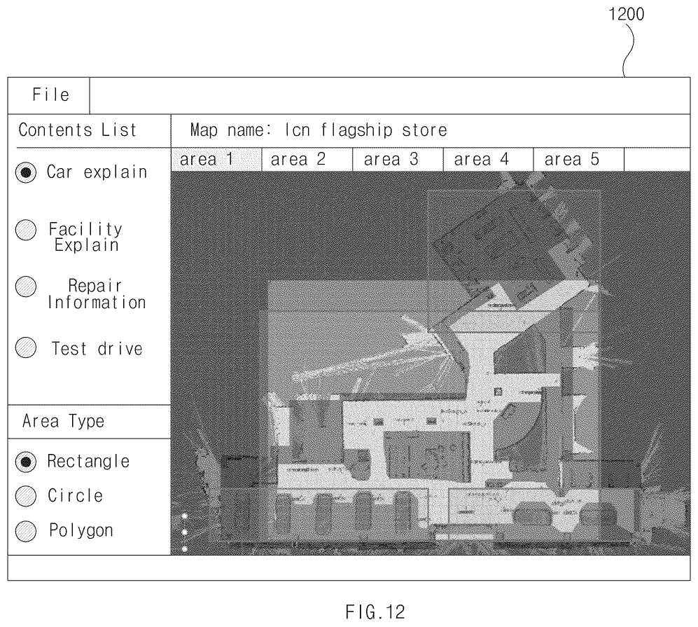

FIG. 12 is a drawing illustrating a guide map generated based on map information in a control server according to an embodiment of the present disclosure.

A control server (e.g., a control server 160 of FIG. 1) according to an embodiment may generate a guide map 1200 based on map information. The guide map 1200 may be provided together with a target contents list to a user by a guide robot (e.g., a guide robot 100 of FIG. 1).

The guide map 1200 may include a map on which the guide robot moves and pieces of content provided by the guide robot. For example, the guide map 1200 may include a contents list, an area type, a map name, an area, and a map.

The contents list may include a contents list capable of being provided to the guide robot by a control server. Referring to FIG. 12, the contents list may include car explain content, facility explain content, repair information content, and test drive content.

The area type may include a type in which pieces of content included in the above-mentioned contents list are able to be displayed on the guide map 1200. For example, the area type may include a rectangle type, a circle type, and a polygon type. For reference and for convenience of description in the specification, the area type displayed on the guide map 1200 is shown and mainly described as the rectangle type.

The map name may indicate a name of the guide map 1200, specifically, a file name. For example, the map name may be represented as “Icn flagship store.” In other words, the guide map 1200 shown in FIG. 12 may include a movable area where the guide robot is able to provide content in the “Icn flagship store” in an airport.

The guide map 1200 may be updated, when the guide robot performs an initialization operation or is in an idle state. Furthermore, the guide map 1200 may be converted into an extensible markup language (XML) or JavaScript object notation (JSON) form to be delivered to the guide robot.

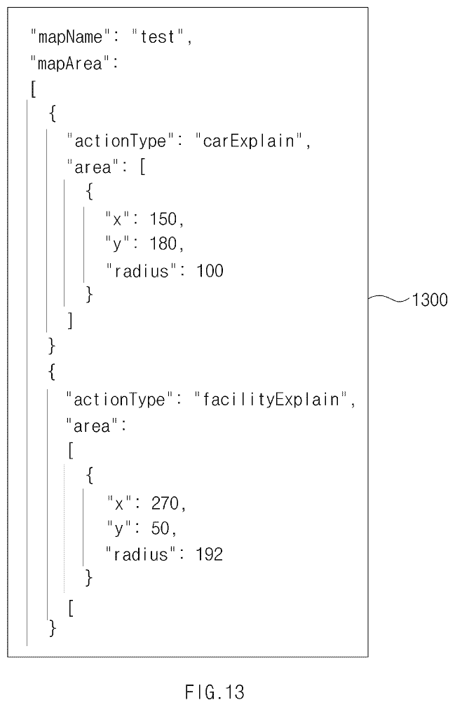

FIG. 13 is a drawing for describing a source code of a guide map according to an embodiment of the present disclosure.

A control server (e.g., a control server 160 of FIG. 1) according to an embodiment may generate a source code 1300 of a guide map. For example, the source code 1300 may include a name (e.g., mapName) of the guide map, an area (e.g., mapArea) of the guide map, an action type (e.g., actionType), and information (e.g., area) about an area.

The name of the guide map may be a name determined by a user and/or a manager. The area of the guide map may include an area where content is provided to a user on the guide map. Referring to FIG. 13, the area of the guide map may include an area where car explain content is provided to the user and an area where facility explain is provided to the user.

The action type may indicate content capable of being provided to the user by the guide robot. In this regard, the information about the area may include information about an area for providing content on the guide map for each action type. The information about the area may include a center point including an x-coordinate value with respect to a horizontal axis of the guide map and a y-coordinate value with respect to a vertical axis of the guide map and may include a radius (e.g., radius) with respect to the center point.

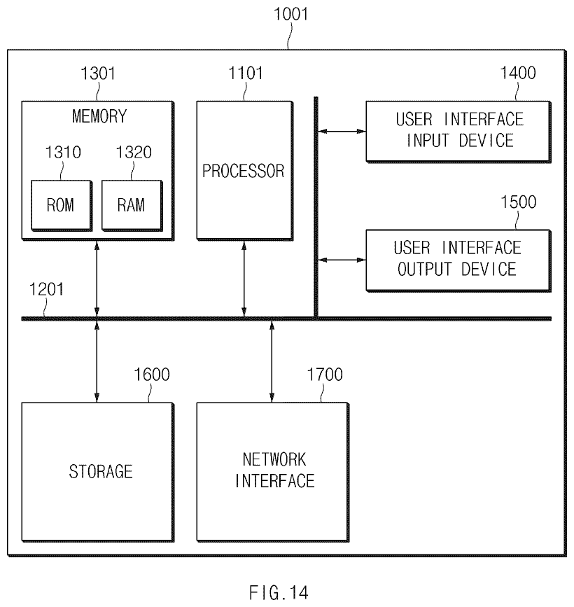

FIG. 14 is a drawing illustrating a computing system associated with a guide robot, a control server, and a guide robot control method according to an embodiment of the present disclosure.

Referring to FIG. 14, a computing system 1001 about the guide robot, the control server, and the guide robot control method may include at least one processor 1101, a memory 1301, a user interface input device 1400, a user interface output device 1500, storage 1600, and a network interface 1700, which can be connected with each other via a bus 1201, any or all of which may be in plural.

The processor 1101 may be a central processing unit (CPU) or a semiconductor device that processes instructions stored in the memory 1301 and/or the storage 1600. The memory 1301 and the storage 1600 may include various types of volatile or non-volatile storage media, for example. For example, the memory 1301 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1101. The software module may reside on a storage medium (that is, the memory 1301 and/or the storage 1600) such as a RAM, a flash memory, a ROM, an EPROM, an EEPROM, a register, a hard disc, a removable disk, a CD-ROM, or any combination thereof, for example.

The example storage medium may be coupled to the processor 1101. The processor 1101 may read out information from the storage medium and may write information in the storage medium. Alternatively, the storage medium may be integrated with the processor 1101. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to example embodiments and the accompanying drawings, the present disclosure is not necessarily limited thereto, and may be variously modified and altered by those skilled in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute code/instructions and respond. A processing unit may perform an operating system (OS) or a software application running on the OS. Further, the processing unit may access, store, manipulate, process, and generate data in response to execution of software. It can be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves and configured to be interpreted by the processing unit or to provide instructions or data to the processing unit. Software may be dispersed throughout computer systems connected via networks and may be stored or executed in a dispersion manner. Software and data may be recorded in one computer-readable storage media.

The methods according to embodiments may be implemented in the form of program instructions that may be executed through various computer devices and may be recorded in computer-readable media. The computer-readable media may include program code/instructions, data files, data structures, and the like alone or in combination, and the program code/instructions recorded on the media may be specially designed and configured for an example or may be known and usable to those skilled in the art of computer software. Examples of computer-readable media can include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like, for example. Program code/instructions can include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the embodiments are described with reference to restricted drawings, it may teach one skilled in the art that the embodiments can be variously changed or modified based on the above description. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

A description will be given of advantages of the guide robot, the control server, and the guide robot control method according to an embodiment of the present disclosure.

According to at least one of embodiments of the present disclosure, the guide robot may provide the user with a target contents list in which pieces of data obtained from the image recognition device and the position recognition device are reflected to selectively provide content which matches an expected behavior according to the position of the guide robot in a service area of the guide robot and the position of the user, thus effectively providing the user with the content.

Furthermore, according to at least one of embodiments of the present disclosure, the guide robot may perform an update of pieces of content included in map information by comparing pieces of content stored in the control server with pieces of content included in the map information, thus failing to provide or reducing to provide the user with unnecessary content and allowing the user to increase the availability and usage of the guide robot.

Furthermore, according to at least one of embodiments of the present disclosure, the guide robot may divide the content recommendation device for reflecting a position of the guide robot and a characteristic of the user to obtain a target contents list and the data management device for storing and managing content to efficiently distribute the amount of calculation of data, provide the user with pieces of specialized content, and provide various pieces of content depending to the position of the same guide robot, thus increasing the utilization of the robot.

In addition, variations and various advantages ascertained directly or indirectly through the present disclosure may be provided. Therefore, other implements, other embodiments, and equivalents to claims can be within the scope of the following claims.

Therefore, embodiments of the present disclosure are not intended to limit the technical spirit of the present disclosure, and are provided for illustrative purposes. The scope of the present disclosure can be construed on the basis of the accompanying claims, and technical ideas within scopes equivalent to the claims can be included in the scope of the present disclosure.

What is claimed is:

1. A guide robot, comprising:
a position recognition device configured to recognize a position of the guide robot;
an image recognition device configured to recognize a user from a target image obtained from an image sensor;
a behavior controller configured to transmit a request for generating a target contents list, in which the position of the guide robot and a characteristic of the user are reflected, to a content recommendation device, in response to a call of the user, and output the target contents list through an output device of the guide robot, based on receiving the target contents list from the content recommendation device; and
the content recommendation device configured to combine the position of the guide robot with map information to generate first feature data and generate second feature data about the characteristic of the user from the target image, obtain the target contents list by applying the first feature data and the second feature data to a content recommendation model, and transmit the target contents list to the behavior controller.

2. The robot of claim 1, wherein the position recognition device is further configured to:
obtain a preceding time point at which the guide robot moves, the preceding time point being close to a target time point at which the position of the guide robot is recognized, among previous time points with respect to the target time point,
combine a position of the guide robot at the preceding time point and a position of the guide robot at the target time point with the map information to obtain a direction of the guide robot at the target time point, and
transmit to the content recommendation device at least one of or both of the position of the guide robot at the target time point and the direction of the guide robot at the target time point.

3. The robot of claim 2, wherein the content recommendation device is further configured to:
generate the first feature data including at least one of or both of the position of the guide robot at the target time point and the direction of the guide robot at the target time point,
sort at least one piece of content included in map information in an order based on straight-line distance from the position of the guide robot, the position being included in the first feature data, and
apply the sorted at least one content and the first feature data to the content recommendation model to obtain a first sub-contents list including pieces of content associated with a direction opposite to the direction of the guide robot, wherein the first sub-contents list is included in the target contents list.

4. The robot of claim 1, wherein the image recognition device is further configured to:
recognize at least one of or any combination of gender information of the user, age information of the user, and face information of the user, from the target image,
generate information about tracking of the face information, in response to the face information being recognized from the target image, and
transmit to the content recommendation device one of or both of the recognized information and the information about the tracking; and
wherein the content recommendation device is further configured to:
generate the second feature data including one of or both of the recognized information and the information about the tracking, and
apply the second feature data to the content recommendation model to obtain a second sub-contents list including pieces of content in which the characteristic of the user is reflected among at least one content included in the map information, wherein the second sub-contents list is included in the target contents list.

5. The robot of claim 1, further comprising a data management device configured to:
perform an update of at least one piece of content included in the map information,
transmit to a control server a version of each of at least one piece of content included in the map information,
perform an update of pieces of content different from a version of content stored in the control server in the version of each of the at least one piece of content included in the map information, and
transmit an update failure notification to the behavior controller, in response to the update of the pieces of content different from the version of the content included in the map information and stored in the control server failing more than a selected number of times.

6. The robot of claim 5, wherein the data management device is further configured to:
obtain an initial position of the guide robot on the basis of a time point for which power is applied to the guide robot, in response to a time the power is applied to the guide robot being less than a selected first threshold,
perform the update of the pieces of content different from the version of the content included in the map information and stored in the control server, in response to the guide robot stopping at the initial position, and
transmit to the behavior controller a request to move the guide robot to a selected waiting position, in response to the update failure notification being transmitted to the behavior controller.

7. The robot of claim 5, wherein the data management device is further configured to:
obtain a time for which an idle state of the guide robot continues, in response to the guide robot being in the idle state,
perform the update of the pieces of content different from the version of the content included in the map information and stored in the control server, in response to the time being greater than a selected second threshold, and
transmit to the behavior controller a request to move the guide robot to a selected waiting position, in response to the update failure notification being transmitted to the behavior controller.

8. The robot of claim 5, wherein the data management device is further configured to:
obtain a state of charge of the guide robot, in response to the guide robot being in a charge state,
perform the update of the pieces of content different from the version of the content included in the map information and stored in the control server, in response to the state of charge being greater than or equal to a selected third threshold, and
transmit to the behavior controller a request to maintain the charge of the guide robot, in response to the update failure notification being transmitted to the behavior controller.

9. The robot of claim 1, wherein the content recommendation device is further configured to transmit to behavior controller pieces of data about a graphic object in which each of pieces of content included in the target contents list is displayed as a selected area, in response to receiving a resource about the target contents list from a control server.

10. A control server, comprising:
a memory storing computer-executable code;
at least one processor configured to access the memory and execute the code; and
a communication device configured to perform communication with a guide robot,
wherein the code comprises instructions for the at least one processor to cause the control server to:
generate map information including a point where the guide robot is located and including pieces of content to which the guide robot is able to guide a user,
extract a piece of common content capable of being provided to a user in a first area on the basis of the position where the guide robot is located and pieces of specialized content capable of being provided to the user in a second area on the basis of the point where the guide robot is located, from among pieces of content stored in the control server, and
transmit to the guide robot the map information, the pieces of extracted common content, and the pieces of extracted specialized content, in response to a request of the guide robot.

11. The server of claim 10, wherein the code comprises instructions for the at least one processor to cause the control server to:
generate a guide map on which the pieces of extracted content are displayed as a selected area, based on the map information, and
transmit the guide map to the guide robot, in response to a resource request of a content recommendation device of the guide robot.

12. A guide robot control method, comprising:
recognizing a position of a guide robot;
recognizing a user from a target image obtained from an image sensor;
transmitting a request for generating a target contents list in which the position of the guide robot and a characteristic of the user are reflected to a content recommendation device, in response to a call of the user;
combining the position of the guide robot with map information to generate first feature data;
generating second feature data about the characteristic of the user from the target image;
transmitting to a behavior controller the target contents list obtained by applying each of the first feature data and the second feature data to a content recommendation model; and
outputting the target contents list through an output device of the guide robot.

13. The method of claim 12, wherein the recognizing of the position of the guide robot comprises:
obtaining a preceding time point at which the guide robot moves, the preceding time point being proximate to a target time point at which the position of the guide robot is recognized, among previous time points with respect to the target time point;
combining a position of the guide robot at the preceding time point and a position of the guide robot at the target time point with the map information to obtain a direction of the guide robot at the target time point; and
transmitting to the content recommendation device one of or both of the position of the guide robot at the target time point and the direction of the guide robot at the target time point.

14. The method of claim 13, further comprising:
generating the first feature data including the one of or both of the position of the guide robot at the target time point and the direction of the guide robot at the target time point;
sorting at least one piece of content included in map information in an order based on a straight-line distance from the position of the guide robot, the position being included in the first feature data; and
applying the sorted at least one content and the first feature data to the content recommendation model to obtain a first sub-contents list including pieces of content associated with a direction opposite to the direction of the guide robot and included in the target contents list.

15. The method of claim 12, wherein the recognizing of the user comprises:
recognizing, from the target image, one of or any combination of gender information of the user, age information of the user, and face information of the user;
generating information about tracking of the face information, in response to the face information being recognized from the target image;
transmitting, to the content recommendation device, one of or both of the recognized information and the information about the tracking;
generating the second feature data including the one of or both of the recognized information and the information about the tracking; and
applying the second feature data to the content recommendation model to obtain a second sub-contents list including pieces of content in which the characteristic of the user is reflected among at least one piece of content included in the map information and included in the target contents list.

16. The method of claim 12, further comprising:
transmitting to a control server a version of each of at least one piece of content included in the map information;
performing an update of pieces of content different from a version of content stored in the control server in the version of each of the at least one piece of content included in the map information; and
transmitting an update failure notification to the behavior controller, in response to the update of the pieces of content different from the version of the content included in the map information and stored in the control server failing more than a selected number of times.

17. The method of claim 16, wherein the performing of the update comprises:
obtaining an initial position of the guide robot on the basis of a time point for which power is applied to the guide robot, in response to a time for which the power is applied to the guide robot being less than a selected first threshold;
performing the update of the pieces of content different from the version of the content included in the map information and stored in the control server, in response to the guide robot stopping at the initial position; and
transmitting a request to move the guide robot to a selected waiting position to the behavior controller, in response to the update failure notification being transmitted to the behavior controller.

18. The method of claim 16, wherein the performing of the update comprises:
obtaining a time for which an idle state of the guide robot continues, in response to the guide robot being in the idle state;
performing the update of the pieces of content different from the version of the content included in the map information and stored in the control server, in response to the time being greater than a selected second threshold; and
transmitting a request to move the guide robot to a selected waiting position to the behavior controller, in response to the update failure notification being transmitted to the behavior controller.

19. The method of claim 16, wherein the performing of the update comprises:
obtaining a state of charge of the guide robot, in response to the guide robot being in a charge state;
performing the update of the pieces of content different from the version of the content included in the map information and stored in the control server, in response to the state of charge being greater than or equal to a selected third threshold; and
transmitting a request to maintain the charge of the guide robot to the behavior controller, in response to the update failure notification being transmitted to the behavior controller.

20. The method of claim 12, further comprising:
generating the map information including a point where the guide robot is located and including pieces of content to which the guide robot is able to guide the user;
extracting pieces of common content capable of being provided to the user in a first area on the basis of the position where the guide robot is located and pieces of specialized content capable of being provided to the user in a second area on the basis of the point where the guide robot is located, among pieces of content stored in a control server; and
transmitting the map information, the pieces of extracted common content, and the pieces of extracted specialized content to the guide robot, in response to a request of the guide robot.
